(19) United States
(12) Patent Application Publication
(10) Pub. No.: US 2025/0328532 A1
(43) Pub. Date: Oct. 23, 2025

(54) Database Cache Layer

(71) Applicant: Salesforce, Inc., San Francisco, CA (US)

(72) Inventors: Charan Reddy Guttapalem, Fremont, CA (US); Venkateswararao Jujjuri, Beaverton, OR (US)

(21) Appl. No.: 18/643,507

(22) Filed: Apr. 23, 2024

(51) Int. Cl. G06F 16/2455; G06F 16/2457

(52) U.S. Cl. CPC G06F 16/24552; G06F 16/24573

(57) ABSTRACT

Techniques are disclosed relating to implementing a cache layer for a distributed database system. In some embodiments, a distributed computing system that includes a plurality of physical nodes implementing a hosting service deploys, to a first of the plurality of physical nodes, a container that implements a cache for a distributed database system hosted by the hosting service. The container is executable to store the cache in a memory internal to the first physical node. The container receives, from the database system, a data request for data maintained in a persistent storage external to the first physical node. In response to determining that the requested data resides in the cache, the container services the data request from the internal memory of the first physical node.

### BACKGROUND

### Technical Field

This disclosure relates generally to database systems, and, more specifically, to database storage.

### Description of the Related Art

Database systems can be implemented across multiple cluster nodes to ensure availability, scalability, and fault tolerance. In this distributed architecture, database data can be partitioned or replicated across various cluster nodes, which can enable database systems to handle larger volumes of data and a higher number of transactions than would be possible with a single node system. Moreover, the data stored in a given physical node may be replicated across multiple availability zones. This can ensure continued operation even when one or more cluster nodes in an availability zone goes down as other nodes in different availability zones potentially remain accessible.

### BRIEF DESCRIPTION OF THE DRAWINGS

FIG. 1 is a block diagram illustrating one embodiment of a computing system that implements a database cache for a database system that maintains data in a separate persistent storage.

FIG. 2A-2C are block diagram illustrating embodiments of the computing system in which containers deployed to multiple physical nodes implement a cache layer in local memories of the physical nodes.

FIG. 3A and 3B are diagram illustrating embodiments of a cache rehydration after a container restart.

FIG. 4 is a block diagram illustrating one embodiment of a cache rehydration performed by a container that failed to receive a write request.

FIGS. 5A-5C are flow diagrams illustrating embodiments of methods associated with implementing a database cache layer.

FIG. 6 is a block diagram illustrating one embodiment of an exemplary multi-tenant system for implementing various systems described herein.

### DETAILED DESCRIPTION

Database systems may implement a cache layer between a persistent storage and a database server/database node to retrieve data from the cache layer at a comparatively lower latency than retrieving that data from the persistent storage. One approach to implementing this cache layer for a database system hosted by a cloud-based platform (e.g., Amazon Web Services® (AWS)) is mounting a network attached storage (e.g., an AWS Elastic Block Storage (EBS)) external to the physical node/server blade hosting the database system, which can provide better performance than a persistent object storage (e.g., an Amazon Simple Storage Service® (Amazon S3) bucket). This approach can still have potential downsides, however. The physical separation of the network attached storage to the database node can add considerable latency to cache accesses resulting in database requests taking longer to be provided. Hosting platforms may also charge additional fees for using attached block storages based on the rate that data is accessed, the size of accessed data, etc. These downsides can be further exacerbated when a database system is distributed across multiple physical nodes (PNs), which may reside in different availability zones (AZs).

The present disclosure describes embodiments in which a cache layer of a database system is implemented by one or more deployed containers that maintain caches within memories of their respective PNs. As will be described below, a distributed computing system can include a plurality of PNs implementing a hosting service. A distributed database system hosted by the hosting service may maintain its data in a persistent storage. To improving the performance of database queries attempting to access this data, one or more containers are deployed to one or more PNs to implement caches (or portions of a distributed cache) within the internal memories of the PNs (as opposed to some external storage such as a network attached storage). Accordingly, a given container can receive a data request from the distributed database system (and potentially from another container within the same PN and implementing, at least, a portion of the distributed database system). In response to determining that the requested data resides in the cache, the container can service the data request from the internal memory of the physical node without having to retrieve the data from the persistent storage external to the physical node. Implementing a cache layer in this manner can provide lower latencies (and potentially lower costs) than other approaches such as those noted above. Various techniques for rehydrating a given container's cache after a potential failure will also be discussed in order to enable the cache layer to achieve high availability (HA).

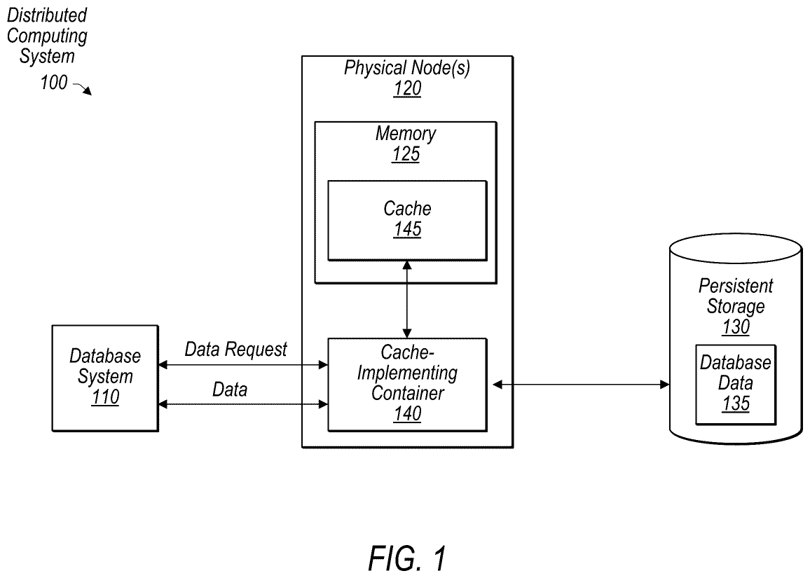

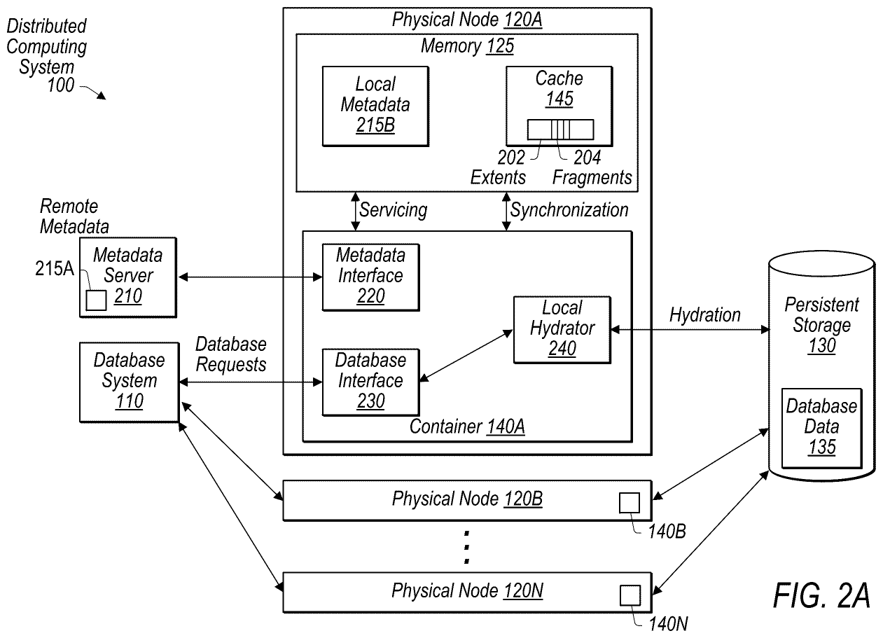

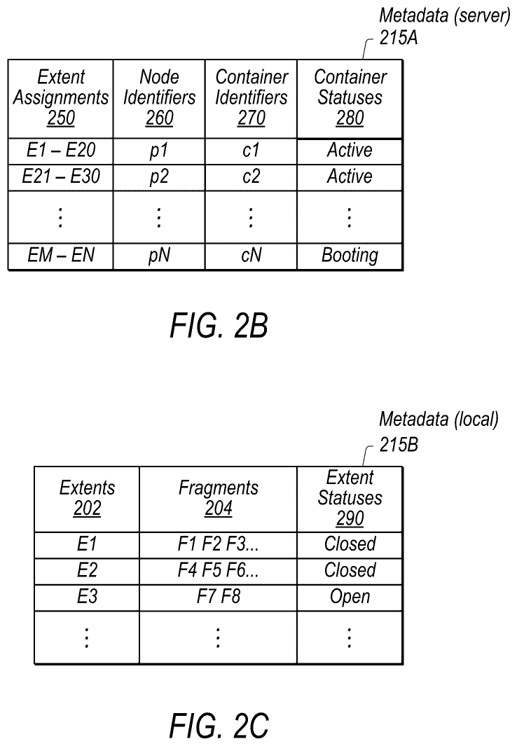

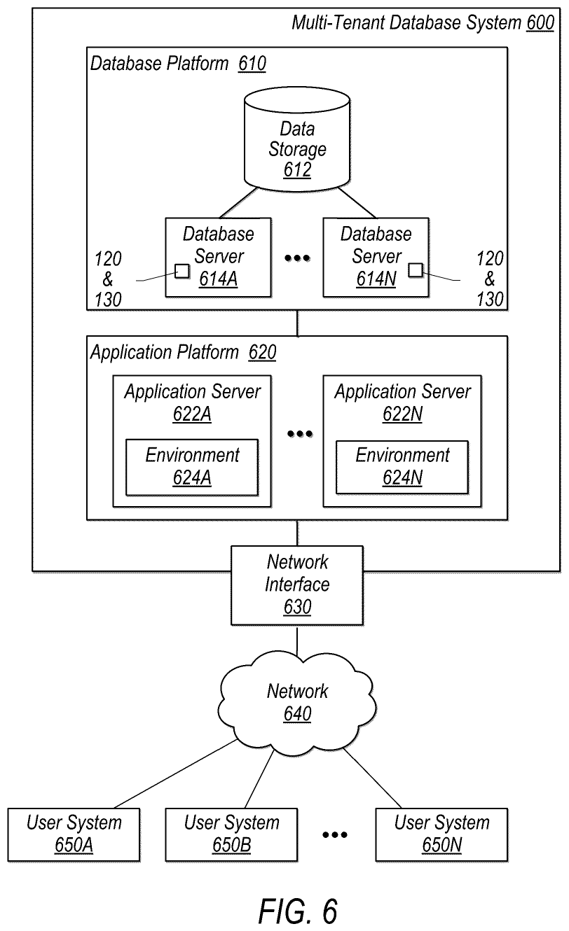

Turning now to FIG. 1, a block diagram of a distributed computing system 100 is depicted. In illustrated embodiment, distributed computing system 100 includes a database system 110, one or more physical nodes 120, and persistent storage 130. Physical nodes 120 further include internal memory 125 and a cache-implementing container 140. In some embodiments, distributed computing system 100 may be implemented differently than shown. For example, distributed computing system 100 may include more components such as those discussed below with respect to FIGS. 2A and 6.

Distributed computing system 100, in some embodiments, implements a hosting service (e.g., Amazon Web Services®, Microsoft® Azure, Google® Cloud) that allows users of that service to provision various resources (e.g., computing resources, storage resources, network resources, etc.). Examples of such resources may include database system 110, persistent storage 130, container 140, etc. Computing system 100 may be distributed across multiple physical computing systems, which may be distributed across multiple AZs. For example, distributed computing system 100 may be implemented by multiple server farms, which may reside in different geographic locations. In other embodiments, however, system 100 is implemented utilizing a local or private infrastructure as opposed to a public cloud.

Database system 110 may correspond to any suitable database system. In some embodiments, system 100 is a relational database management system (RDBMS), which may be implemented using, for example, Oracle®, MySQL®, Microsoft® SQL Server, PostgreSQL®, IBM® DB2, etc. Accordingly, system 110 may be configured to store data in one or more data tables, indexes, temporary, tables, etc. for servicing data requests. In some embodiments, data requests are expressed using structured query language (SQL); but in other embodiments, other query declarative languages may be supported. In some embodiments, database system 110 may include a multi-tenant database in which multiple tenants may each store a respective set of data in the database. For example, the multi-tenant database may include a first set of data belonging to a non-profit organization (e.g., a first tenant) and a set of data belonging to a company (e.g., a second tenant). In some embodiments, database system 110 is a distributed database system that is implemented across multiple PNs such as nodes 120.

Physical nodes 120 are physical computers configured to implement a hosting service of distributed computing system 100. For example, PNs 120 may be blade/rack servers inserted into server racks, which may correspond to one or more Amazon Elastic Compute Cloud® (EC2) instances. As part of providing a host service, PNs 120 may host containers that implement a lightweight, standalone, and portable execution environments for applications and their dependencies. PNs 120 may support any suitable types of containers including virtual machines (VMs), Docker® containers, Linux Containers (LXCs), Amazon® Machine Images (AMI), etc. For example, database system 110 may execute within multiple containers hosted on PNs 120. As shown, a PN 120 can also execute container 140. To implement various functionality, PNs 120 include one or more processors and internal memory 125, which may be referred to as an instance storage. Internal memory 125 may include non-volatile memory such as hard disk drives (HDDs), solid state drives (SSDs), optical storage, etc., as well as various volatile memory including DRAM, DDR RAM, SRAM, EDO RAM, Rambus RAM, etc. Memory 125 may include program instructions such as those of container 140, data such as cache 145, etc.

Persistent storage 130, in various embodiments, stores database data 135 for database system 110. Persistent storage 130 may be implemented using a single or multiple storage devices that are connected together on a network (e.g., a storage attached network (SAN), network attached storage (NAS), etc.) and configured to redundantly store information in order to prevent data loss. In some embodiments, data 135 written to persistent storage 130 may be persisted across multiple AZs using a replication service. In some embodiments, persistent storage 130 is implemented as an object storage in contrast to memory 125, which, in some embodiments, implements a block storage. In some embodiments, persistent storage 130 is a cloud-based storage such as an Amazon S3® bucket. Persistent storage 130 may also afford different levels quality of service (QOS) based on pricing, physical proximity to PNs 120, etc. As noted above, because persistent storage 130 is external to physical nodes 120, in various embodiments, data requests to persistent storage 130 may experience a significantly higher latency than data requests to internal memory 125.

Cache-implementing container 140, in various embodiments, is a container hosted by a physical node 120 and executable to implement a cache 145 for database system 110 in internal memory 125 in order to reduce the latency for data requests accessing data 135 from persistent storage 130. As will be described in more detail with respect to FIG. 2A, container 140 may be one of multiple containers 140 deployed to multiple nodes 120 that implement portions of a distributed cache layer for database system 110. A given container 140 may also include multiple software components to manage various functions associated with caching database data 135 in cache 145 within memory 125. These functions can include hydration of cache 145 (i.e., the retrieval of data 135 from persistent storage 130 into a cache 145 before the data is requested by database system 110), servicing cache hits from memory 125, and servicing cache misses from persistent storage 130, etc.

Turning now to FIG. 2A, a more detailed block diagram of one embodiment of system 100 is shown. In the illustrated embodiment, system 100 further includes metadata server 210 and multiple PNs 120, which each include respective container 140A-N. A given container 140 includes a metadata interface 220, database interface 230, and local hydrator 240. In some embodiments, system 100 may be implemented differently than shown.

Metadata server 210 stores various metadata 215A used by components of system 100 including database system 110 and containers 140 to coordinate operation with one another. To persist metadata 215A across multiple AZs, metadata server 210 may also be implemented within multiple containers deployed to physical nodes 120, which, in some embodiments, may execute instances of Apache® Zookeeper. As one example, metadata 215A may include the assignments of extents 202 to containers 140 in various embodiments. In particular, containers 140 may be assigned different portions of database data 135 to maintain in their respective caches 145 in order to distribute loads across containers 140. In some embodiments, database data 135 is stored in persistent storage 130 within files, which may be referred to herein as extents 202. Each extent 202 may include multiple fragments 204, which each store a respective database record of data 135. Metadata server 210 may also track additional metadata 215A such as discussed below with FIGS. 2B and 2C.

Metadata interface 220, in various embodiments, is a set of program instructions executable to interface with metadata server 210 including retrieving a local copy of metadata 215B from metadata server 210, which may be stored in memory 125. Metadata interface 220 may retrieve metadata 215A from metadata server 210 after a boot of container 140 and periodically afterwards in order to coordinate container 140's operation with other components of system 100 including performance of hydration of cache 145 as will be discussed.

Database interface 230, in various embodiments, is a set of program instructions executable to service database requests from database system 110. Accordingly, database interface 230 may a read request from database system 110 for data 135 maintained in persistent storage 130 and examine cache 145 to determine whether a cached copy of the data 135 is present in cache 145. In response to determining that the requested data 135 resides in cache 145 (i.e., a cache hit occurred), database interface 230 may service the read request by providing the data 135 from internal memory 125—reducing the latency to service the read request. If, however, the requested data 135 did not reside in cache 145 (i.e., a cache miss occurred), database interface 230 may service the read request by providing the data 135 from persistent storage 130. In some embodiments, this may include retrieving, into cache 145, the entire extent 202 that includes the relevant fragment 204 (as well as other irrelevant fragments 204) and providing the relevant fragment 204 including the requested data 135 to database system 110. Database interface 230 may also receive write requests from database system 110. In an embodiment in which cache 145 is implemented as a write-through cache, database interface 230 performs a write through operation that includes concurrently writing data 135 associated with the write request to cache 145 and persistent storage 130. In other embodiments in which cache 145 is implemented as a write-back cache, database interface 230 may write data 135 at a later point to persistent storage 130 such as when a currently open extent 202 becomes filled with fragments 204, is marked as closed, and then evicted to persistent storage 130. In some embodiments, database interface 230 may communicate with local hydrator 240 when reading and writing to persistent storage 130.

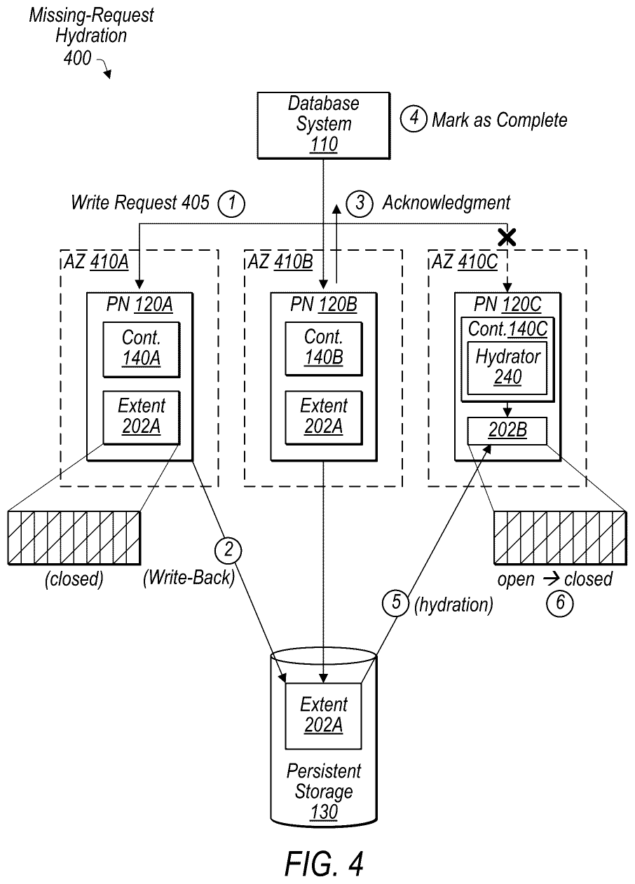

Local hydrator 240, in various embodiments, is a set of program instructions executable to hydrator/preload cache 145 with data 135 in order to avoid incurring latency hits due to cache misses. Local hydrator 240 may perform a hydration operation after a container 140 boots (or is restarted) in which metadata interface 220 sends, to metadata server 210, a request for metadata 215 identifying a set of data assigned to the container 140 for rehydration into cache 145 and local hydrator 240 retrieves, using metadata 215, the identified set of data from persistent storage 130 and into memory internal 125. Local hydrator 240 may also perform hydration operations in response to other situations such as a container 140 failing to receive write request received by other containers 140 as will be discussed with FIG. 4, a container 140 hydrating only closed extents 202 during boot and delaying hydrating open extents 202 currently being written to by other containers 140, etc.

Turning now to FIG. 2B, a block diagram of an example of server-side metadata 215A is depicted. As shown, metadata 215A includes extent assignments 250, physical node identifiers 260, container identifiers 270, and container statuses 280. In other embodiments, metadata 215A may include additional information such as extent statuses 290 discussed with FIG. 2C and/or be organized differently.

Extent assignments 250 may identify distributions of extents 202 for physical nodes 120 and/or containers 140 in physical nodes 120. For example, as shown, extents E1-E20 may be assigned to a physical node 120 having an identifier 260 p1 and a container 140 having a container identifier 260 c1, extents E21-E30 may be assigned to physical node 120 having an identifier p2 and another container 140 having a container identifier 260 c2, and so forth. As noted above, a given container 140 may retrieve its assignment 250 and use it to hydrate its cache 145. In some embodiments, a container 140 advertises its availability to service data requests from database system 110 before it has completely hydrated its cache 145. Accordingly, the container 140 may retrieve a subset of the identified data/extents 202 assigned to the container. In response to the retrieved subset satisfying a threshold (e.g., 90% of the assigned extents 202, 90% of the capacity of cache 145, etc.), the container 140 may join the cluster of other containers 140 implementing the cache layer and advertise its availability to service cache requests. For example, in FIG. 2B, a container 140 may change its status 280 from booting to active. After this advertising, the container 140 may continue retrieve the remaining identified data/extents 202 assigned to the container 140.

In various embodiments, a given container 140 also uses metadata 215 recorded in metadata server 215A to determine whether it is performing an initial boot or is rebooting after some failure, which may affect whether the container 140 performs an initial hydration. If a container 140 is performing an initial boot in conjunction with the initializing of database system 110, there may not be data 135 available for hydration. If, however, a container 140 experienced a failure and was restarted while database system 110 is operational, the container 140 was likely caching data 135 before the restart and may attempt to rehydrate the data 135 before rejoining the other containers 140 in implementing the cache layer. In some embodiments, a given container 140 records information in metadata 215 about itself to indicate whether its current boot is an initial one or one resulting from a restart. This metadata may include storing, after a successful initial boot, a container identifier 270, a container status 280, a successful-boot cookie, or some other indicator.

Turning now to FIG. 2C, a block diagram of an example of local metadata 215B stored in a given physical node 120 is depicted. As shown, metadata 215B may include a list of extents 202 present in memory 125 along with some indication of the fragments 204 included those extents 202. For example, an extent E1 may include fragments F1, F2, F3, and so forth while extent E2 may include fragments F4, F5, F6, and so forth. Metadata 215B may also identify an extent status 290 for an extent 202. An extent 202 may be identified as open if it is being actively being written to—i.e., fragments 204 are being recorded into an extent 202 in response to write requests from database system 110. Once an extent 202 reaches a predetermined capacity, its status may be changed to closed (meaning it is no longer being written to) and a new open extent 202 may be used to record newly received data 135 in new fragments 204. As the statuses 290 of extents changes, these information may be recorded in metadata server 210 to capture the current state of database system 110 and be propagated other containers 140 to ensure that they remain consistent with this state as will be discussed with FIG. 4.

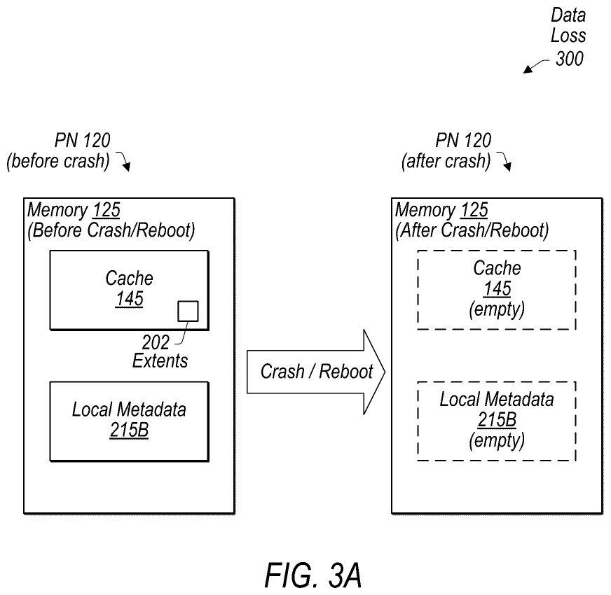

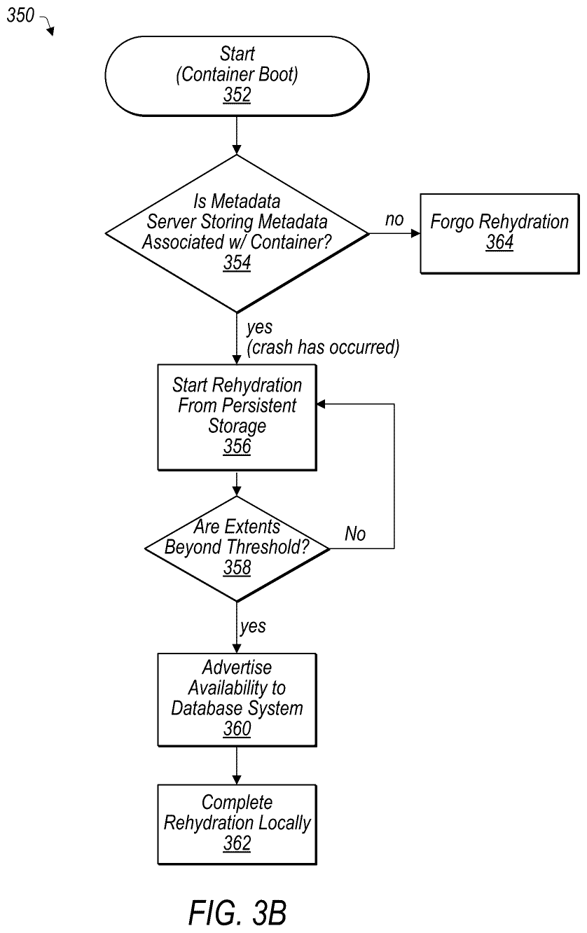

Turning now to FIG. 3A, a block diagram of data loss 300 of the contents of memory 125 is depicted. In some embodiments, physical nodes 120 implement a memory purging policy in which a given container's data is removed from memory 125 when a container is restarted or shutdown. Such a policy may be implemented due to the limited amount of memory 125 in a physical node 120, a desire restore containers to a default state devoid of errors, etc. In do so, however, a physical node 120 may destroy the current state of a container 140, which may include removing the contents of cache 145 and any locally stored metadata 215B. As a given container 140 may experience an error/crash that can be rectified by restarting a container 140, it is desirable to have a reliable recovery method for containers 140 in order to achieve a cache layer with high availability.

Turning now to FIG. 3B, an example flow chart for an initialization method 350 is depicted. As will be discussed, initialization method 350 may be performed in conjunction with a containers boot process (or shortly thereafter) and allow a given container 140 to recover if it was restarted due to some issue.

Method 350 may begin at step 352 with a container 140 attempting to boot, which may include the container loading a guest operating system, initializing kernel extensions or drivers, initiating execution of components 220-240 and their dependencies, etc. At step 354, the container 140 may determine whether metadata server 210 stores any metadata 215, which may be indicative of a prior execution session of the container 140—and thus indicative that the present boot is not the initial boot. As noted above, in some embodiments, this metadata 215 may include the presence of container identifier 270, a container status 280, or some other indicator. If container 140 has successfully implemented the cache 145 previously as determined from this metadata 215, then method 350 may proceed to step 356 in which the container 140 performs rehydration. If no metadata is found in metadata server 210 indicative of a prior successful boot, then method 350 may proceed to step 364 in which the container 140 forgoes performance of a rehydration operation and advertises an ability of the container 140 to service data requests from the database system 110.

During step 356, container 140 may request extent assignments 250 from metadata server 210 and begin rehydrating those extents 202 into cache 145. As container 140 performs the rehydration, the container 140 determines, at step 358, whether the number of rehydrated extents 202 stratifies a particular threshold (e.g., 90% of the extents 202 being hydrated). If the rehydrated extents 202 are under the threshold, the container 140 continues to rehydrate the cache 145 until the threshold is met. Once the threshold is met, method 350 proceeds to step 360 in which the container 140 advertises its ability to service data requests from the database system 110. As noted above, this may include updating a status 280 in metadata server 210. Then, the container 140 may proceed to complete the rehydration locally at step 312. Steps 310-312 advantageously allow containers 140 to service requests without waiting for hydration to complete and thus reduces delays for initializing a container 140.

Although not depicted in FIG. 3, a given container 140 may continue to periodically perform hydration for extents 202 when other circumstances arise such as those discussed next.

Turning now to FIG. 4, a block diagram of a hydration 400 for a missing write request is depicted. In some embodiments, database system 110 implements a quorum mechanism in which database system 110 sends the same write request to containers 140 in multiple PNs 120 residing in different AZs 410. If the containers 140 are able to successfully service the write request, they each respond with an acknowledgment indicating that the write was successful. If the database system 110 receives acknowledgments from a majority of the container 140 recipients, database system 110 determines that the write operation was successful and may mark the database transaction corresponding to the write request as successfully committed. As will be discussed, this approach can greatly improve the reliability of system 100.

A given container 140 may fail to acknowledge a write request for various reasons. For example, a given connection may be severed to a particular AZ 410, a loss of one or more PNs 120 at a given AZ 410 may occur, a given container 140 may be suffering performance issues (or has crashed), etc. Hydration 400 may provide a way to account for these issues.

In the example depicted in FIG. 4, database system 110 has issued a write request 405 at step 1 to each of containers 140A-C in three PNs 120A-C located in three AZs 410A-C. This write request, however, did not arrive at AZ 410C in this example. At step 2, containers 140A and 140B write the data associated with the request to their respective caches 145 and persistent storage 130. In the depicted example, writing the fragment 204 including the data 135 results in an extent 202A being closed out and written to persistent storage 130. Containers 140A and 140B then respond with corresponding acknowledgments. Container 140C's extent 202B, however, remains open as it did not receive the write request. Container 140C also fails to send a corresponding acknowledgment.

Because database system 110 still receives acknowledgments from a majority of the containers 140 (two of three containers), database system 110 deems the write operation to be successful and may mark the database transaction corresponding to the write request as committed. In some embodiments, this may include database system 110 updating metadata 215 in metadata server 210 to identifying the most recently committed transaction (or using some other approach to provide an indication to containers 140 that the write request was serviced). Container 140C may determine, from this indication, that it did not receive the write request and, based on this determinization, may hydrating data associated with the write request from persistent storage 130 into its cache 145. As shown, this may include container 140C loading the entire extent 202A from persistent storage 130 and replacing the outdated extent 202B. Thus, system 100 is able to recover from a situation in which a given container 140 does not receive one or more database requests.

Although hydration 400 is depicted in the context of a missing write request, a similar hydration 400 may also be used to hydrate extents 202 that are not loaded when container 140 performs method 350 discussed. For example, in some embodiments, a given container 140 may hydrate only closed extents 202 stored in persistent storage 130 during boot as it may be too resource intensive to coordinate hydrating open extents 202 that are being actively written to by other containers 140. Instead, a given container 140 may use hydration 400 to identify open extents 202 that closed subsequent to performing method 350 and hydrate them afterwards via persistent storage 130 as depicted in FIG. 4.

It is also worth noting that this quorum mechanism may also improve the reliability of servicing read requests as requested data 135 may be received from more than one AZ 410. Continuing with the example depicted in FIG. 4, a given read request may originate from a database node residing in AZ 410C but fail to be serviced by container 140C—e.g., the database node and container 140C reside on different physical nodes 120 having trouble communicating. Because the read request is sent to containers 140 in other AZs 410, the database node can still receive the requested data 135 from one containers 140A or 140B without having to potentially rely on persistent storage 130 in this example.

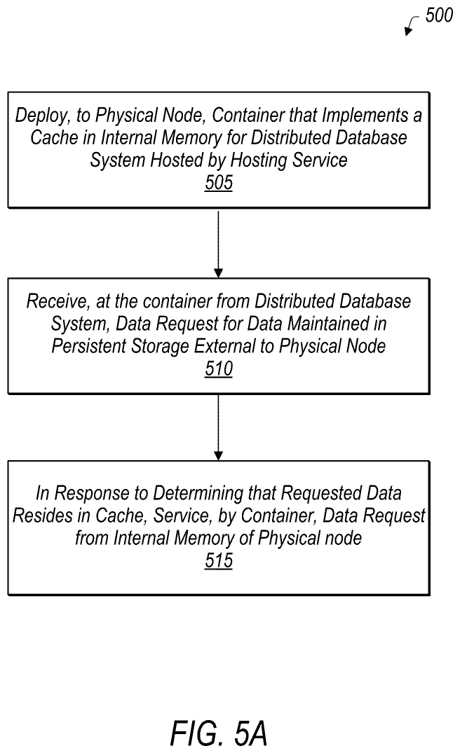

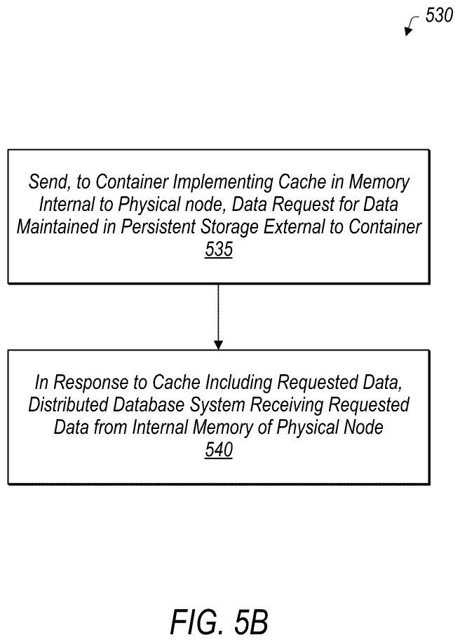

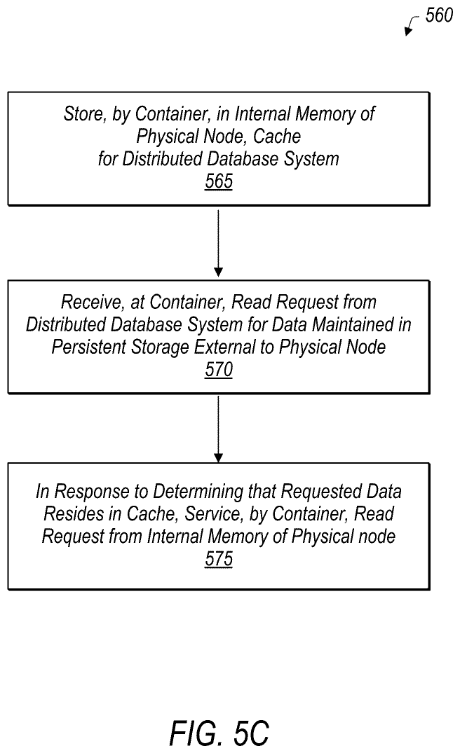

Turning now to FIG. 5A, a flow diagram of a method 500 is shown. Method 500 is one embodiment of a method that is performed by a computing system that implements a database cache as described herein such as distributing computing system 100. In various embodiments, method 500 may be performed by executing program instructions stored on a non-transitory computer-readable storage medium. In some embodiments, method 500 includes more or fewer steps than shown.

In step 505, a container (e.g., container 140) that implements a cache (e.g., cache 145) for a distributed database system (e.g., database system 110) hosted by a hosting service is deployed to a first of the plurality of physical nodes (e.g., physical nodes 120) implementing the hosting service. In various embodiments, the container is executable to store the cache in a memory internal to the first physical node. In some embodiments, a plurality of containers that implement portions of a distributed cache for the distributed database system are deployed, in different availability zones (e.g., AZs 410) of the hosting service, the deployed container being one of the plurality of containers. In some embodiments, another container is deployed to the first physical node, implements, at least, a portion of the distributed database system, and provides a data request.

In step 510, a data request is received at the container from the distributed database system, the data request being for data (e.g., database data 135) maintained in a persistent storage (e.g., persistent storage 130) external to the first physical node.

In step 515, in response to determining that the requested data resides in the cache, the container services the data request from the internal memory of the first physical node.

In some embodiments, method 500 further includes receiving, at two or more of the containers of the physical nodes, a write request to store data in the persistent storage. In response to the write request, the two or more containers performs write operations in respective caches implemented by the two or more containers; at least one of the two or more containers performs a write operation to persistent storage. In some embodiments, in response to the write operations, each of the two or more containers provides an acknowledgment to the write request. In response to a majority of the plurality of containers acknowledging the write request, an indication is received from the database system that a transaction associated with the write request has committed.

In some embodiments, method 500 further includes the container sending, to a metadata server (e.g., metadata server 210), a request for metadata identifying a set of data assigned to the container for hydration into the cache from the persistent storage and retrieving, using the requested metadata, the identified set of data from the persistent storage and into the memory internal of the first physical node. In some embodiments, the retrieving further includes retrieving a subset of the identified data assigned to the container. In response to the retrieved subset satisfying a threshold, the container advertising an availability to service cache requests. After the advertising, the container retrieves the remaining identified data assigned to the container. In some embodiments, the retrieving further includes determining, from the metadata, that a set of data has been written to the persistent storage by one or more other containers implementing respective caches and, based on the determining, the container rehydrating the set of data into the cache implemented by the container.

In some embodiments, method 500 further includes storing, at a metadata server (e.g., metadata server 210), metadata indicating that the container has successfully implemented the cache. After a boot of the container, the container determines whether the metadata is present in the metadata server to determine whether that the boot was not an initial boot. In such an embodiment, a reboot of the container causes loss of data in the internal memory of the first physical node. In response to determining that the boot was not an initial boot, the container initiates a rehydration operation of the cache using data from the persistent storage. In some embodiments, in response to determining that the boot was an initial boot, the container forgoes performance of the rehydration operation and advertises an ability of the container to service data requests from the database system.

Turning now to FIG. 5B, a flow diagram of a method 530 is shown. Method 530 is one embodiment of a method that is performed by a computing system that hosts a distributed database system using a database cache as described herein such as distributing computing system 100. In various embodiments, method 530 may be performed by executing program instructions stored on a non-transitory computer-readable storage medium. In some embodiments, method 530 includes more or fewer steps than shown.

In step 535, the distributed database system (e.g., database system 110) sends, to a container (e.g., container 140) that implements a cache (e.g., cache 145), a data request for data maintained in a persistent storage (e.g., persistent storage 130) external to the container. In various embodiments, the container is deployed to a first of a plurality of physical nodes (e.g., physical nodes 120) implementing a hosting service that hosts the distributed database system. In various embodiments, the container maintains the cache in a memory (e.g., memory 125) internal to the first physical node. In some embodiments, the data request is sent by a second container implementing the distributed database system and deployed to the first physical node.

In step 540, in response to the cache including the requested data, the distributed database system receives the requested data from the internal memory of the first physical node. In some embodiments, the distributed database system sends the data request to containers deployed to multiple ones of the physical nodes and implementing the cache in a plurality of available zones and receives, at a first of the available zones, the requested data from one of the deployed containers in a second of the available zones.

In some embodiments, method 530 further includes the distributed database system sending a write request to a plurality of containers implementing the cache in a plurality of available zones. In response to a majority of the containers acknowledging the write request, the distributed database system providing an indication (e.g., via metadata 215) that a database transaction corresponding to the write request has committed. In some embodiments, the container determines from the indication that the container did not receive the write request and, based on the determining, hydrates data associated with the write request from the persistent storage into the cache.

Turning now to FIG. 5C, a flow diagram of a method 560 is shown. Method 560 is one embodiment of a method that is performed by a container that implements a database cache as described herein such as container 140. In various embodiments, method 560 may be performed by executing program instructions stored on a non-transitory computer-readable storage medium. In some embodiments, method 560 includes more or fewer steps than shown.

Method 560 begins in step 565 with the container storing, in an internal memory (e.g., memory 125) of a first of the plurality of physical nodes (e.g., a node 120), a cache (e.g., 145) for a distributed database system (e.g., database system 110). In step 570, the container receives, from the distributed database system, a read request for data maintained in a persistent storage (e.g., persistent storage 130) external to the first physical node. In step 575, in response to determining that the requested data resides in the cache, the container services the read request from the internal memory of the first physical node.

In some embodiments, method 560 further includes the container receiving a write request from the distributed database system and, in response to the write request, the container performing a write through operation that includes concurrently writing data associated with the write request to the cache and the persistent storage.

In some embodiments, method 560 further includes the container receiving, from the distributed database system, a second read request for a database record stored in the persistent storage. In response to determining that the database record is not in the cache, the container retrieves, into the cache from the persistent storage, a file (e.g., an extent 202) that includes a plurality of database records (e.g., fragments 204) and provides the data record from the file in a response to the second read request.

In some embodiments, method 560 further includes restarting the container on the first physical node in response to detecting a failure of the container. The container rehydrates (e.g., via local hydrator 240) the cache including sending, to a metadata server (e.g., metadata server 210), a request for metadata identifying a set of data assigned to the container and retrieves, from the persistent storage, the identified set of data into the memory internal of the first physical node.

In some embodiments, method 560 further includes the container accessing a metadata server to determine that a majority of containers hosted by others of the plurality of physical nodes have serviced a write request that was not received by the container and included writing data to the persistent storage. Based on the accessing, the container hydrating the written data into the cache from the persistent storage.

### Exemplary Multi-Tenant Database System

Turning now to FIG. 6, an exemplary multi-tenant database system (MTS) 600, which may implement functionality of system 100, is depicted. In the illustrated embodiment, MTS 600 includes a database platform 610, an application platform 620, and a network interface 630 connected to a network 640. Database platform 610 includes a data storage 612 and a set of database servers 614A-N that interact with data storage 612, and application platform 620 includes a set of application servers 622A-N having respective environments 624. In the illustrated embodiment, MTS 600 is connected to various user systems 650A-N through network 640. In other embodiments, techniques of this disclosure are implemented in non-multi-tenant environments such as client/server environments, cloud computing environments, clustered computers, etc.

MTS 600, in various embodiments, is a set of computer systems that together provide various services to users (or sets of users alternatively referred to as “tenants”) that interact with MTS 600. In some embodiments, MTS 600 implements a customer relationship management (CRM) system that provides mechanism for tenants (e.g., companies, government bodies, etc.) to manage their relationships and interactions with customers and potential customers. For example, MTS 600 might enable tenants to store customer contact information (e.g., a customer's website, email address, telephone number, and social media data), identify sales opportunities, record service issues, and manage marketing campaigns. Furthermore, MTS 600 may enable those tenants to identify how customers have been communicated with, what the customers have bought, when the customers last purchased items, and what the customers paid. To provide the services of a CRM system and/or other services, as shown, MTS 600 includes a database platform 610 and an application platform 620.

Database platform 610, in various embodiments, is a combination of hardware elements and software routines that implement database services for storing and managing data of MTS 600, including tenant data. As shown, database platform 610 includes data storage 612. Data storage 612, in various embodiments, includes a set of storage devices (e.g., solid state drives, hard disk drives, etc.) that are connected together on a network (e.g., a storage attached network (SAN)) and configured to redundantly store data to prevent data loss. Data storage 612 may implement a single database, a distributed database, a collection of distributed databases, a database with redundant online or offline backups or other redundancies, etc. In various embodiments, data storage 612 implements persistent storage 130 discussed above.

In various embodiments, a database record may correspond to a row of a table. A table generally contains one or more data categories that are logically arranged as columns or fields in a viewable schema. Accordingly, each record of a table may contain an instance of data for each category defined by the fields. For example, a database may include a table that describes a customer with fields for basic contact information such as name, address, phone number, fax number, etc. A record therefore for that table may include a value for each of the fields (e.g., a name for the name field) in the table. Another table might describe a purchase order, including fields for information such as customer, product, sale price, date, etc. In various embodiments, standard entity tables are provided for use by all tenants, such as tables for account, contact, lead and opportunity data, each containing pre-defined fields. MTS 600 may store, in the same table, database records for one or more tenants—that is, tenants may share a table. Accordingly, database records, in various embodiments, include a tenant identifier that indicates the owner of a database record. As a result, the data of one tenant is kept secure and separate from that of other tenants so that that one tenant does not have access to another tenant's data, unless such data is expressly shared.

In some embodiments, data storage 612 is organized as part of a log-structured merge-tree (LSM tree). As noted above, a database server 614 may initially write database records into a local in-memory buffer data structure before later flushing those records to the persistent storage (e.g., in data storage 612). As part of flushing database records, the database server 614 may write the database records into new files/extents that are included in a “top” level of the LSM tree. Over time, the database records may be rewritten by database servers 614 into new files included in lower levels as the database records are moved down the levels of the LSM tree. In various implementations, as database records age and are moved down the LSM tree, they are moved to slower and slower storage devices (e.g., from a solid-state drive to a hard disk drive) of data storage 612.

When a database server 614 wishes to access a database record for a particular key, the database server 614 may traverse the different levels of the LSM tree for files that potentially include a database record for that particular key. If the database server 614 determines that a file may include a relevant database record, the database server 614 may fetch the file from data storage 612 into a memory of the database server 614. The database server 614 may then check the fetched file for a database record having the particular key. In various embodiments, database records are immutable once written to data storage 612. Accordingly, if the database server 614 wishes to modify the value of a row of a table (which may be identified from the accessed database record), the database server 614 writes out a new database record into the buffer data structure, which is purged to the top level of the LSM tree. Over time, that database record is merged down the levels of the LSM tree. Accordingly, the LSM tree may store various database records for a database key such that the older database records for that key are located in lower levels of the LSM tree then newer database records.

Database servers 614, in various embodiments, are hardware elements, software routines, or a combination thereof capable of providing database services, such as data storage, data retrieval, and/or data manipulation Such database services may be provided by database servers 614 to components (e.g., application servers 622) within MTS 600 and to components external to MTS 600. As an example, a database server 614 may receive a database transaction request from an application server 622 that is requesting data to be written to or read from data storage 612. The database transaction request may specify an SQL SELECT command to select one or more rows from one or more database tables. The contents of a row may be defined in a database record and thus database server 614 may locate and return one or more database records that correspond to the selected one or more table rows. In various cases, the database transaction request may instruct database server 614 to write one or more database records for the LSM tree-database servers 614 maintain the LSM tree implemented on database platform 610. In some embodiments, database servers 614 implement a relational database management system (RDMS) or object-oriented database management system (OODBMS) that facilitates storage and retrieval of information against data storage 612. In various cases, database servers 614 may communicate with each other to facilitate the processing of transactions. For example, database server 614A may communicate with database server 614N to determine if database server 614N has written a database record into its in-memory buffer for a particular key.

Application platform 620, in various embodiments, is a combination of hardware elements and software routines that implement and execute CRM software applications as well as provide related data, code, forms, web pages and other information to and from user systems 650 and store related data, objects, web page content, and other tenant information via database platform 610. In order to facilitate these services, in various embodiments, application platform 620 communicates with database platform 610 to store, access, and manipulate data. In some instances, application platform 620 may communicate with database platform 610 via different network connections. For example, one application server 622 may be coupled via a local area network and another application server 622 may be coupled via a direct network link. Transfer Control Protocol and Internet Protocol (TCP/IP) are exemplary protocols for communicating between application platform 620 and database platform 610, however, it will be apparent to those skilled in the art that other transport protocols may be used depending on the network interconnect used.

Application servers 622, in various embodiments, are hardware elements, software routines, or a combination thereof capable of providing services of application platform 620, including processing requests received from tenants of MTS 600. Application servers 622, in various embodiments, can spawn environments 624 that are usable for various purposes, such as providing functionality for developers to develop, execute, and manage applications. Data may be transferred into an environment 624 from another environment 624 and/or from database platform 610. In some cases, environments 624 cannot access data from other environments 624 unless such data is expressly shared. In some embodiments, multiple environments 624 can be associated with a single tenant.

Application platform 620 may provide user systems 650 access to multiple, different hosted (standard and/or custom) applications, including a CRM application and/or applications developed by tenants. In various embodiments, application platform 620 may manage creation of the applications, testing of the applications, storage of the applications into database objects at data storage 612, execution of the applications in an environment 624 (e.g., a virtual machine of a process space), or any combination thereof. In some embodiments, application platform 620 may add and remove application servers 622 from a server pool at any time for any reason, there may be no server affinity for a user and/or organization to a specific application server 622. In some embodiments, an interface system (not shown) implementing a load balancing function (e.g., an F6 Big-IP load balancer) is located between the application servers 622 and the user systems 650 and is configured to distribute requests to the application servers 622. In some embodiments, the load balancer uses a least connections algorithm to route user requests to the application servers 622. Other examples of load balancing algorithms, such as are round robin and observed response time, also can be used. For example, in certain embodiments, three consecutive requests from the same user could hit three different servers 622, and three requests from different users could hit the same server 622.

In some embodiments, MTS 600 provides security mechanisms, such as encryption, to keep each tenant's data separate unless the data is shared. If more than one server 614 or 622 is used, they may be located in close proximity to one another (e.g., in a server farm located in a single building or campus), or they may be distributed at locations remote from one another (e.g., one or more servers 614 located in city A and one or more servers 622 located in city B). Accordingly, MTS 600 may include one or more logically and/or physically connected servers distributed locally or across one or more geographic locations.

One or more users (e.g., via user systems 650) may interact with MTS 600 via network 640. User system 650 may correspond to, for example, a tenant of MTS 600, a provider (e.g., an administrator) of MTS 600, or a third party. Each user system 650 may be a desktop personal computer, workstation, laptop, PDA, cell phone, or any Wireless Access Protocol (WAP) enabled device or any other computing device capable of interfacing directly or indirectly to the Internet or other network connection. User system 650 may include dedicated hardware configured to interface with MTS 600 over network 640. User system 650 may execute a graphical user interface (GUI) corresponding to MTS 600, an HTTP client (e.g., a browsing program, such as Microsoft's Internet Explorer™ browser, Netscape's Navigator™M browser, Opera's browser, or a WAP-enabled browser in the case of a cell phone, PDA or other wireless device, or the like), or both, allowing a user (e.g., subscriber of a CRM system) of user system 650 to access, process, and view information and pages available to it from MTS 600 over network 640. Each user system 650 may include one or more user interface devices, such as a keyboard, a mouse, touch screen, pen or the like, for interacting with a graphical user interface (GUI) provided by the browser on a display monitor screen, LCD display, etc. in conjunction with pages, forms and other information provided by MTS 600 or other systems or servers. As discussed above, disclosed embodiments are suitable for use with the Internet, which refers to a specific global internetwork of networks. It should be understood, however, that other networks may be used instead of the Internet, such as an intranet, an extranet, a virtual private network (VPN), a non-TCP/IP based network, any LAN or WAN or the like.

Because the users of user systems 650 may be users in differing capacities, the capacity of a particular user system 650 might be determined one or more permission levels associated with the current user. For example, when a salesperson is using a particular user system 650 to interact with MTS 600, that user system 650 may have capacities (e.g., user privileges) allotted to that salesperson. But when an administrator is using the same user system 650 to interact with MTS 600, the user system 650 may have capacities (e.g., administrative privileges) allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level. There may also be some data structures managed by MTS 600 that are allocated at the tenant level while other data structures are managed at the user level.

In some embodiments, a user system 650 and its components are configurable using applications, such as a browser, that include computer code executable on one or more processing elements. Similarly, in some embodiments, MTS 600 (and additional instances of MTSs, where more than one is present) and their components are operator configurable using application(s) that include computer code executable on processing elements. Thus, various operations described herein may be performed by executing program instructions stored on a non-transitory computer-readable medium and executed by processing elements. The program instructions may be stored on a non-volatile medium such as a hard disk, or may be stored in any other volatile or non-volatile memory medium or device as is well known, such as a ROM or RAM, or provided on any media capable of staring program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the disclosed embodiments can be implemented in any programming language that can be executed on a server or server system such as, for example, in C, C+, HTML, Java, JavaScript, or any other scripting language, such as VBScript.

Network 640 may be a LAN (local area network), WAN (wide area network), wireless network, point-to-point network, star network, token ring network, hub network, or any other appropriate configuration. The global internetwork of networks, often referred to as the “Internet” with a capital “I,” is one example of a TCP/IP (Transfer Control Protocol and Internet Protocol) network. It should be understood, however, that the disclosed embodiments may utilize any of various other types of networks.

User systems 650 may communicate with MTS 600 using TCP/IP and, at a higher network level, use other common Internet protocols to communicate, such as HTTP, FTP, AFS, WAP, etc. For example, where HTTP is used, user system 650 might include an HTTP client commonly referred to as a “browser” for sending and receiving HTTP messages from an HTTP server at MTS 600. Such a server might be implemented as the sole network interface between MTS 600 and network 640, but other techniques might be used as well or instead. In some implementations, the interface between MTS 600 and network 640 includes load sharing functionality, such as round-robin HTTP request distributors to balance loads and distribute incoming HTTP requests evenly over a plurality of servers.

In various embodiments, user systems 650 communicate with application servers 622 to request and update system-level and tenant-level data from MTS 600 that may require one or more queries to data storage 612. In some embodiments, MTS 600 automatically generates one or more SQL statements (the SQL query) designed to access the desired information. In some cases, user systems 650 may generate requests having a specific format corresponding to at least a portion of MTS 600. As an example, user systems 650 may request to move data objects into a particular environment 624 using an object notation that describes an object relationship mapping (e.g., a JavaScript object notation mapping) of the specified plurality of objects.

The various techniques described herein and all disclosed or suggested variations, may be performed by one or more computer programs. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

Similarly, systems that implement the methods described with respect to any of the disclosed techniques are also contemplated. One such environment in which the disclosed techniques may operate is a cloud computer system. A cloud computer system (or cloud computing system) refers to a computer system that provides on-demand availability of computer system resources without direct management by a user. These resources can include servers, storage, databases, networking, software, analytics, etc. Users typically pay only for those cloud services that are being used, which can, in many instances, lead to reduced operating costs. Various types of cloud service models are possible. The Software as a Service (SaaS) model provides users with a complete product that is run and managed by a cloud provider. The Platform as a Service (PaaS) model allows for deployment and management of applications, without users having to manage the underlying infrastructure. The Infrastructure as a Service (IaaS) model allows more flexibility by permitting users to control access to networking features, computers (virtual or dedicated hardware), and data storage space. Cloud computer systems can run applications in various computing zones that are isolated from one another. These zones can be within a single or multiple geographic regions.

A cloud computer system includes various hardware components along with software to manage those components and provide an interface to users. These hardware components include a processor subsystem, which can include multiple processor circuits, storage, and I/O circuitry, all connected via interconnect circuitry. Cloud computer systems thus can be thought of as server computer systems with associated storage that can perform various types of applications for users as well as provide supporting services (security, load balancing, user interface, etc.).

One common component of a cloud computing system is a data center. As is understood in the art, a data center is a physical computer facility that organizations use to house their critical applications and data. A data center's design is based on a network of computing and storage resources that enable the delivery of shared applications and data.

The term “data center” is intended to cover a wide range of implementations, including traditional on-premises physical servers to virtual networks that support applications and workloads across pools of physical infrastructure and into a multi-cloud environment. In current environments, data exists and is connected across multiple data centers, the edge, and public and private clouds. A data center can frequently communicate across these multiple sites, both on-premises and in the cloud. Even the public cloud is a collection of data centers. When applications are hosted in the cloud, they are using data center resources from the cloud provider. Data centers are commonly used to support a variety of enterprise applications and activities, including, email and file sharing, productivity applications, customer relationship management (CRM), enterprise resource planning (ERP) and databases, big data, artificial intelligence, machine learning, virtual desktops, communications and collaboration services.

Data centers commonly include routers, switches, firewalls, storage systems, servers, and application delivery controllers. Because these components frequently store and manage business-critical data and applications, data center security is critical in data center design. These components operate together to provide the core infrastructure for a data center: network infrastructure, storage infrastructure and computing resources. The network infrastructure connects servers (physical and virtualized), data center services, storage, and external connectivity to end-user locations. Storage systems are used to store the data that is the fuel of the data center. In contrast, applications can be considered to be the engines of a data center. Computing resources include servers that provide the processing, memory, local storage, and network connectivity that drive applications. Data centers commonly utilize additional infrastructure to support the center's hardware and software. These include power subsystems, uninterruptible power supplies (UPS), ventilation, cooling systems, fire suppression, backup generators, and connections to external networks.

Data center services are typically deployed to protect the performance and integrity of the core data center components. Data center therefore commonly use network security appliances that provide firewall and intrusion protection capabilities to safeguard the data center. Data centers also maintain application performance by providing application resiliency and availability via automatic failover and load balancing.

One standard for data center design and data center infrastructure is ANSI/TIA-942. It includes standards for ANSI/TIA-942-ready certification, which ensures compliance with one of four categories of data center tiers rated for levels of redundancy and fault tolerance. A Tier 1 (basic) data center offers limited protection against physical events. It has single-capacity components and a single, nonredundant distribution path. A Tier 2 data center offers improved protection against physical events. It has redundant-capacity components and a single, nonredundant distribution path. A Tier 3 data center protects against virtually all physical events, providing redundant-capacity components and multiple independent distribution paths. Each component can be removed or replaced without disrupting services to end users. A Tier 4 data center provides the highest levels of fault tolerance and redundancy. Redundant-capacity components and multiple independent distribution paths enable concurrent maintainability and one fault anywhere in the installation without causing downtime.

Many types of data centers and service models are available. A data center classification depends on whether it is owned by one or many organizations, how it fits (if at all) into the topology of other data centers, the technologies used for computing and storage, and its energy efficiency. There are four main types of data centers. Enterprise data centers are built, owned, and operated by companies and are optimized for their end users. In many cases, they are housed on a corporate campus. Managed services data centers are managed by a third party (or a managed services provider) on behalf of a company. The company leases the equipment and infrastructure instead of buying it. In colocation (“colo”) data centers, a company rents space within a data center owned by others and located off company premises. The colocation data center hosts the infrastructure: building, cooling, bandwidth, security, etc., while the company provides and manages the components, including servers, storage, and firewalls. Cloud data centers are an off-premises form of data center in which data and applications are hosted by a cloud services provider such as AMAZON WEB SERVICES (AWS), MICROSOFT (AZURE), or IBM Cloud.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of. . . . W, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

1. A non-transitory computer-readable medium having program instructions stored thereon that are capable of causing a distributed computing system that includes a plurality of physical nodes implementing a hosting service to perform operations comprising:
deploying, to a first of the plurality of physical nodes, a container that implements a cache for a distributed database system hosted by the hosting service, wherein the container is executable to store the cache in a memory internal to the first physical node;
receiving, at the container, a data request from the distributed database system, wherein the data request is for data maintained in a persistent storage external to the first physical node; and
in response to determining that the requested data resides in the cache, the container servicing the data request from the internal memory of the first physical node.

2. The computer-readable medium of claim 1, wherein the operations further comprise:
deploying, in different availability zones of the hosting service, a plurality of containers that implement portions of a distributed cache for the distributed database system, wherein the deployed container is one of the plurality of containers.

3. The computer-readable medium of claim 2, wherein the operations further comprise:
receiving, at two or more of the plurality of containers of the plurality of physical nodes, a write request to store data in the persistent storage;
in response to the write request:
performing, by the two or more containers, write operations in respective caches implemented by the two or more containers; and
performing, by at least one of the two or more containers, a write operation to persistent storage.

4. The computer-readable medium of claim 3, wherein the operations further comprise:
in response to the write operations, providing, by each of the two or more containers, an acknowledgment to the write request; and
in response to a majority of the plurality of containers acknowledging the write request, receiving, from the database system, an indication that a transaction associated with the write request has committed.

5. The computer-readable medium of claim 1, wherein the operations further comprise:
deploying, to the first physical node, another container that implements, at least, a portion of the distributed database system and provides the data request.

6. The computer-readable medium of claim 1, wherein the operations further comprise:
sending, by the container and to a metadata server, a request for metadata identifying a set of data assigned to the container for rehydration into the cache from the persistent storage; and
retrieving, by the container using the requested metadata, the identified set of data from the persistent storage and into the memory internal of the first physical node.

7. The computer-readable medium of claim 6, wherein the retrieving further includes:
retrieving a subset of the identified data assigned to the container;
in response to the retrieved subset satisfying a threshold, advertising, by the container, an availability to service cache requests; and
after the advertising, retrieving, by the container, remaining identified data assigned to the container.

8. The computer-readable medium of claim 6, wherein the retrieving further includes:
determining, from the metadata, that a set of data has been written to the persistent storage by one or more other containers implementing respective caches; and
based on the determining, the container hydrating the set of data into the cache implemented by the container.

9. The computer-readable medium of claim 1, wherein the operations further comprise:
storing, at a metadata server, metadata indicating that the container has successfully implemented the cache;
after a boot of the container, the container determining whether the metadata is present in the metadata server to determine whether that the boot was not an initial boot, wherein a reboot of the container causes loss of data in the internal memory of the first physical node; and
in response to determining that the boot was not an initial boot, the container initiating a rehydration operation of the cache using data from the persistent storage.

10. The computer-readable medium of claim 9, wherein the operations further comprise:
in response to determining that the boot was an initial boot:
forgoing, by the container, performance of the rehydration operation; and
advertising an ability of the container to service data requests from the database system.

11. A method, comprising:
sending, by a distributed database system and to a container that implements a cache, a data request for data maintained in a persistent storage external to the container, wherein the container is deployed to a first of a plurality of physical nodes implementing a hosting service that hosts the distributed database system, and wherein the container maintains the cache in a memory internal to the first physical node; and
in response to the cache including the requested data, the distributed database system receiving the requested data from the internal memory of the first physical node.

12. The method of claim 11, further comprising:
sending, by the distributed database system, the data request to containers deployed to multiple ones of the physical nodes and implementing the cache in a plurality of available zones; and
receiving, by the distributed database system at a first of the available zones, the requested data from one of the deployed containers in a second of the plurality of available zones.

13. The method of claim 11,
sending, by the distributed database system, a write request to a plurality of containers implementing the cache in a plurality of available zones; and
in response to a majority of the containers acknowledging the write request, the distributed database system providing an indication that a database transaction corresponding to the write request has committed.

14. The method of claim 13, further comprising:
determining, by the container, from the indication that the container did not receive the write request; and
based on the determining, the container hydrating data associated with the write request from the persistent storage into the cache.

15. The method of claim 11, wherein the data request is sent by a second container implementing the distributed database system and deployed to the first physical node.

16. A non-transitory computer-readable medium having program instructions stored therein that are capable of causing a distributed computing system that includes a plurality of physical nodes implementing a hosting service to perform operations comprising:
storing, by a container and in an internal memory of a first of the plurality of physical nodes, a cache for a distributed database system;
receiving, at the container, a read request from the distributed database system, wherein the read request is for data maintained in a persistent storage external to the first physical node; and
in response to determining that the requested data resides in the cache, the container servicing the read request from the internal memory of the first physical node.

17. The computer-readable medium of claim 16, wherein the operations further comprise:
receiving, at the container, a write request from the distributed database system; and
in response to the write request, the container performing a write through operation that includes concurrently writing data associated with the write request to the cache and the persistent storage.

18. The computer-readable medium of claim 16, wherein the operations further comprise:
receiving, at the container and from the distributed database system, a second read request for a database record stored in the persistent storage;
in response to determining that the database record is not in the cache:
retrieving, by the container into the cache from the persistent storage, a file that includes a plurality of database records; and
providing, by the container, the data record from the file in a response to the second read request.

19. The computer-readable medium of claim 16, wherein the operations further comprise:
restarting the container on the first physical node in response to detecting a failure of the container;
rehydrating, by the container, the cache including:
sending, to a metadata server, a request for metadata identifying a set of data assigned to the container; and
retrieving, from the persistent storage, the identified set of data into the memory internal of the first physical node.

20. The computer-readable medium of claim 16, wherein the operations further comprise:
accessing, by the container, a metadata server to determine that a majority of containers hosted by others of the plurality of physical nodes have serviced a write request that was not received by the container and included writing data to the persistent storage; and
based on the accessing, the container hydrating the written data into the cache from the persistent storage.
